(19) United States
(12) Patent Application Publication
(10) Pub. No.: US 2025/0202136 A1
(43) Pub. Date: Jun. 19, 2025

(54) INSULATION DISPLACEMENT CONNECTOR HAVING A SLEEVE

(71) Applicant: ENNOVI INDUSTRIES, INC., East Providence, RI (US)

(72) Inventor: Richard SCHNEIDER, Livonia, MI (US)

(21) Appl. No.: 18/845,683

(22) PCT Filed: Mar. 6, 2023
(86) PCT No.: PCT/US2023/014615

§ 371 Date: Sep. 10, 2024

Related U.S. Application Data
(60) Provisional application No. 63/319,452, filed on Mar. 14, 2022.

(51) Int. Cl. H01R 4/2433

(52) U.S. Cl. CPC H01R 4/2433

(57) ABSTRACT

An insulation displacement connector for making an electrical connection to a wire having an inner metal conductor covered with an outer insulation layer. The insulation displacement connector includes an insulation displacement terminal having a base joined to a pair of spaced-apart legs that define a receptacle configured to receive the wire. The legs have free end portions and interior edges that help define the receptacle. Each of the interior edges has a cutter for disrupting the insulation layer of the wire to permit the conductor to directly contact the at least one interior edge having the cutter. A metallic sleeve extends around a portion of the insulation displacement terminal and applies inward forces against the legs to bias the legs toward each other.

### CROSS-REFERENCE TO RELATED APPLICATION(S)

This application claims the benefit of priority under 35 U.S.C. § 119(e) to U.S. Provisional Patent Application No. 63/319,452 filed on 14 Mar. 2022, which is herein incorporated by reference.

### TECHNICAL FIELD

The present disclosure relates to a connector for use in making an electrical connection to wire, more particularly to an insulation displacement connector (IDC) having an insulation displacement terminal (IDT).

### BACKGROUND

An IDC with an IDT is used to quickly make an electrical connection to an insulated wire. The IDC often includes a housing, inside of which the IDT makes the electrical connection to the wire. Conventionally, an IDT has spaced-apart legs for disposal and movement over an insulated wire to displace or remove its outer coating or cover so as to expose and make contact with the metal conductor underneath.

Typically, an IDC and its associated IDT are constructed for use with narrow gauge wire. Electrical connections for larger gauge wire are typically made by welding or bolted crimps. However, welding is not aesthetically pleasing and is often difficult, if not impossible, in applications with space constraints. Crimped lugs are also not suitable for applications with space constraints. Moreover, crimped lugs are typically expensive. Accordingly, there is a need for IDCs for use with larger gauge wire.

### SUMMARY

In accordance with the disclosure, an insulation displacement connector is provided for making an electrical connection to a wire having an inner metal conductor covered with an outer insulation layer. The insulation displacement connector includes an insulation displacement terminal having a base joined to a pair of spaced-apart legs that define a receptacle configured to receive the wire. The legs have free end portions and interior edges that help define the receptacle. At least one of the interior edges has a cutter for disrupting the insulation layer of the wire to permit the conductor to directly contact the at least one interior edge having the cutter. A sleeve extends around a portion of the insulation displacement terminal and applies inward forces against the legs to bias the legs toward each other. The sleeve does not extend around the free end portions of the legs.

The insulation displacement connector may be part of an expanded connector assembly that includes first and second conductors. The first conductor has a first connection portion with a pair of spaced-apart first arms defining a first receptacle in-between, and a second connection portion with a pair of spaced-apart second arms defining a second receptacle in-between. A blade of the insulation displacement terminal is disposed in the second receptacle. A second sleeve extends around the first conductor and presses against the first and second arms. The second conductor has a tongue with opposing planar surfaces. The tongue is disposed in the first receptacle such that the planar surfaces adjoin interior edges of the first arms of the first conductor.

### BRIEF DESCRIPTION OF THE DRAWINGS

The features, aspects, and advantages of the present invention will become better understood with regard to the following description, appended claims, and accompanying drawings where:

FIG. 1 shows a perspective view of an insulation displacement connector constructed in accordance with an embodiment of the present disclosure;

FIG. 2 shows a perspective view of the insulation displacement connector of FIG. 1, wherein components are separated;

FIG. 3 shows a perspective view of a conductor plate of the insulation displacement connector of FIG. 1;

FIG. 4 shows a perspective view of a sleeve of the insulation displacement connector of FIG. 1;

FIG. 5 shows an elevational view of the sleeve of FIG. 4 mounted to the conductor plate of FIG. 3, wherein features of the conductor plate disposed inside the sleeve are shown in phantom;

FIG. 6 shows a perspective view of the insulation displacement connector of FIG. 1, modified to have press-fit fasteners extending therefrom, the press-fit fasteners being mounted to a printed circuit board;

FIG. 7 shows a perspective view of the insulation displacement connector of FIG. 1, modified to have a blade extending therefrom;

FIG. 8 shows a perspective view of the insulation displacement connector of FIG. 1, modified to have weld tab extending therefrom;

FIG. 9 shows a perspective view of a portion of an electric motor having a plastic mounting ring separated from a busbar assembly;

FIG. 10 shows a top perspective view of a second insulation displacement terminal of a second insulation displacement connector constructed in accordance with a second embodiment, wherein the second insulation displacement terminal is adapted for surface mounting to a planar substrate and has a sleeve partially mounted thereto;

FIG. 11 shows a bottom perspective view of the second insulation displacement terminal of FIG. 10, wherein the sleeve is spaced above the second insulation displacement terminal;

FIG. 12 is a front perspective view of an expanded conductor assembly having features of the insulation displacement connector of FIG. 1 and features of a tuning fork-type connector;

FIG. 13 is a front, side perspective view of the expanded conductor assembly of FIG. 12, wherein components are separated; and

FIG. 14 is a perspective view of a portion of the tuning fork-type connector of the expanded conductor assembly of FIG. 12.

### DETAILED DESCRIPTION OF ILLUSTRATIVE EMBODIMENTS

It should be noted that in the detailed description that follows, identical components have the same reference numerals, regardless of whether they are shown in different embodiments of the present disclosure. It should also be noted that for purposes of clarity and conciseness, the drawings may not necessarily be to scale and certain features of the disclosure may be shown in somewhat schematic form.

Spatially relative terms, such as “top”, “bottom”, “lower”, “above”, “upper”, and the like, are used herein merely for ease of description to describe one element or feature's relationship to another element(s) or feature(s) as they are illustrated in (a) drawing figure(s) being referred to. It will be understood that the spatially relative terms are not meant to be limiting and are intended to encompass different orientations of the device in use or operation in addition to the orientation depicted in the drawings.

In the connector embodiments described below, an insulation displacement terminal (IDT) with a sleeve is mounted in a housing or bracket to form an insulation displacement connector (IDC). The IDC is for use with a wire that may have a conventional construction with an inner metal conductor covered with an outer insulation layer, which may be a coating or sheath composed of an insulating polymeric material. While the IDC is especially adapted for use with larger gauge wire, its use is not limited to larger gauge wire and may be used with any gauge wire. Also, while the IDT is typically used with a housing or a mounting bracket, the IDT may be used alone to connect a wire to another electrical conductor. In such a situation, the IDT alone forms the IDC.

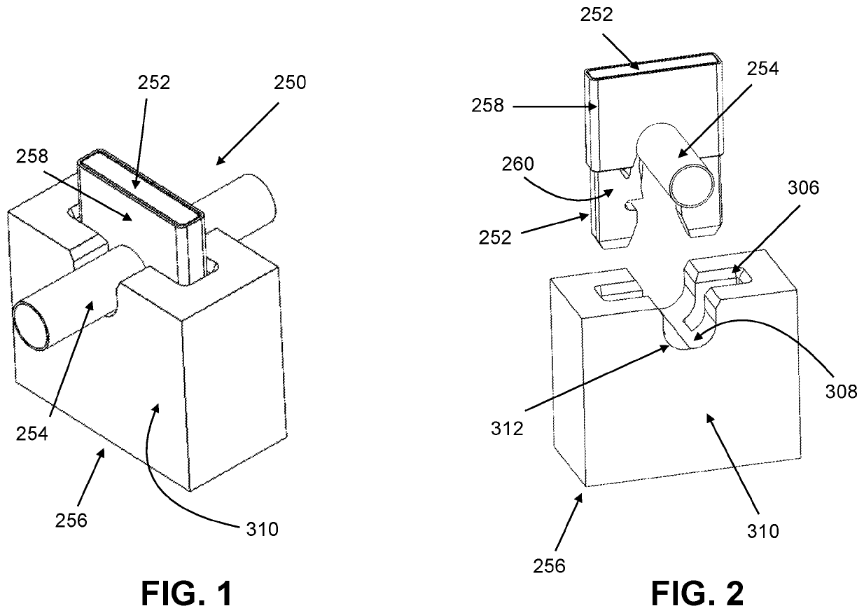

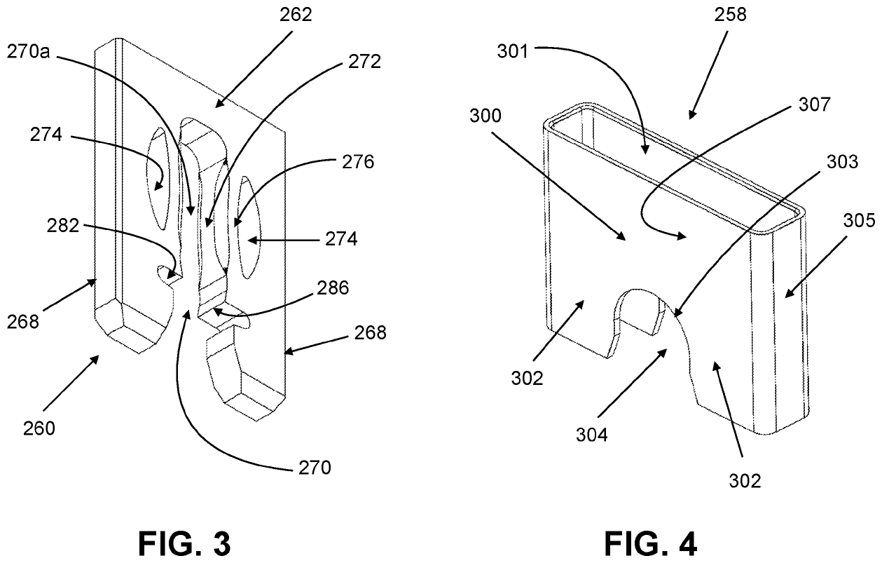

In a first embodiment of the present disclosure, a first IDC 250 is provided that includes an IDT 252, an insulated wire 254, a housing 256 and a sleeve 258, wherein the wire 254 has an outer insulating sheath or layer that encases a metal conductor, such as copper wire. The first IDC 250 and its constituent components are shown in FIGS. 1-5.

The IDT 252 has a low profile and includes one or more conductor plates 260. Each conductor plate 260 has a monolithic unitary structure and is composed of electrically conductive metal, such as copper or a copper alloy, which may or may not be plated with tin. The conductor plate 260 may, by way of non-limiting example, be formed by stamping. Although a single conductor plate 260 is shown in FIGS. 1-5, it should be appreciated that in other embodiments, a plurality of conductor plates 260 may be provided. In these other embodiments, the conductor plates 260 are arranged in a stack in which they may directly contact each other or be separated by thin dielectric layers.

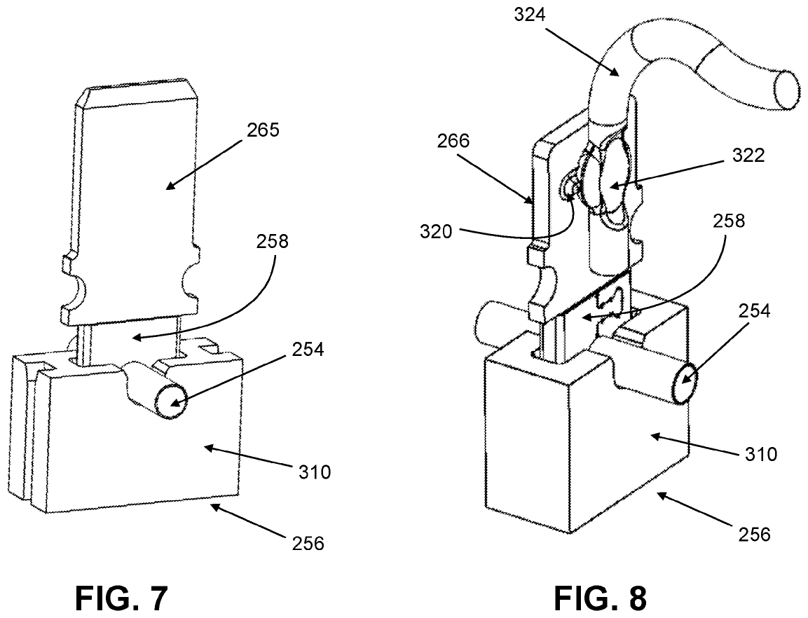

The conductor plate 260 includes a base 262 having a pair of engagement legs 268 extending in a first direction therefrom. A top or first edge of the base 262 extends uninterrupted between opposing sides of the conductor plate 260. In some embodiments, however, one or more projections may extend from the first edge of the base 262 in a second direction, which is opposite the first direction. In these embodiments, each projection is adapted for making an electrical connection with an electrical/electronic device (such as a PCB) and may, by way of non-limiting example, be a press-fit projection 264 for securement in a hole of a PCB, such as is shown in FIG. 6. Alternately, the contact projection may be a pin for soldering in a hole of a PCB, or a blade projection 265, as shown in FIG. 7, or may have some other type of construction, such as a weld projection 266 shown in FIG. 8.

Each engagement leg 268 of the conductor plate 260 has an upper portion joined to the base 262 and a lower portion forming a free end. The engagement legs 268 are spaced-apart to form a receptacle or slot 270 therebetween. The slot 270 has a closed end, located at the base 262, and an open end, located at the free ends. The slot 270 is defined by opposing interior edges 272 of the engagement legs 268, respectively, and has a holding portion 270a. Upper portions of the interior edges 272 have a slight convex curvature (in the direction of the lengths of the engagement legs 268) such that the holding portion 270a is most narrow at a point about midway along the length of the holding portion 270a. In addition, the upper portions of the interior edges 272 may be beveled (in the direction of the thicknesses of the engagement legs 268).

Each engagement leg 268 has an opening 274 extending therethrough, which helps form a flexible portion 276 in each engagement leg 268. The opening 274 is generally elliptical and is defined by a continuous interior surface of the engagement leg 268. A portion of the interior surface located toward the slot 270 is concave and has a center of curvature that corresponds to the narrowest portion of the holding portion 270a. The concave portion of the interior surface and the convex portion of the interior edge 272 help define the flexible portion 276 and provide it with an inwardly-bowed configuration.

The configuration of the flexible portions 276 makes them elastic, but with a high degree stiffness, which enables the flexible portions 276 to store enough force to maintain an acceptable contact force on the wire 254 disposed in the holding portion 270a, even when the cross-section of the wire 254 decreases due to mechanical creep. As such, the flexible portions 276 function as springs to generate a high normal force connection to the wire 254.

Inside notches 282 are formed in the engagement legs 268, toward the free ends, respectively. The inside notches 282 are arcuate and are defined by curved portions of the interior edges 272, respectively, which adjoin the convex portions of the interior edges 272 at sharp corner edges, respectively. The sharp edges extend in the direction of the thickness of the conductor plate 260 and function as scrapers and/or cutters for piercing the insulation layer of the wire 254 and are hereinafter referred to as cutters 286. Below the inside notches 282, the interior edges 272 slope outwardly to the free ends, respectively.

The sleeve 258 has the shape of a pair of short trousers, with a waist portion 300 joined to a pair of leg portions 302 separated by a center passage 304. The waist portion has an opening 301 defined by a continuous edge. Opposing side walls 305 and opposing major walls 307 define both the waist portion 300 and the leg portions 302. Short, closed-ended slots 303 in the major walls 307 help define the center passage 304. The sleeve 258 is hollow and defines an interior space that is configured to tightly receive the width of the IDT 252 (conductor plate(s) 260) in the direction between the side walls 305.

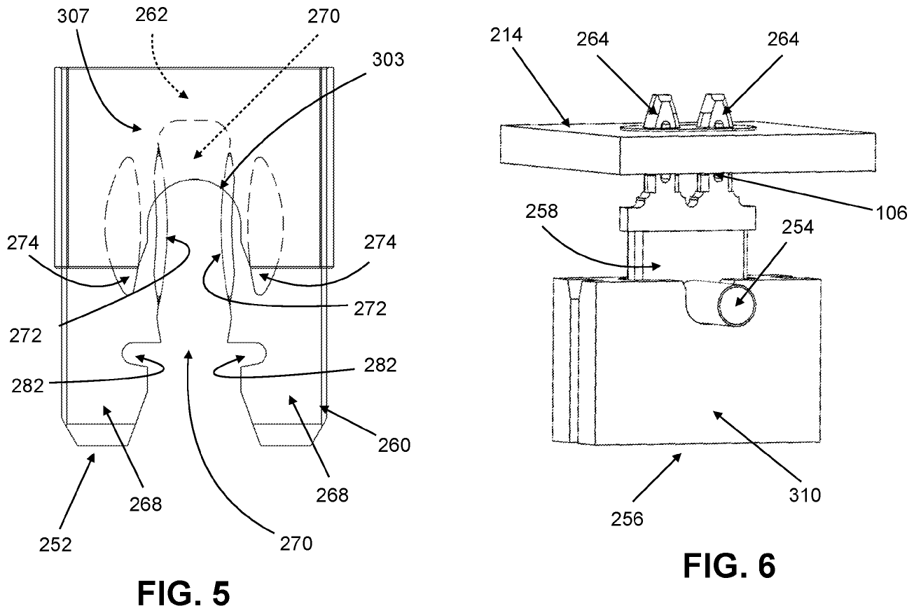

When the sleeve 258 is fully mounted to the IDT 252 (as shown in FIG. 5), the sleeve 258 extends around an upper portion of the IDT 252, but does not extend around a lower portion of the IDT 252. More particularly, the sleeve 258 does not extend around free end portions of the engagement legs 268. In addition, the major walls 307 in the waist portion of the sleeve 258 extend over and cover a portion of the slot 270 located toward its closed end, i.e., the waist portion extends around upper portions of the engagement legs 268. In this manner, the center passage 304 of the sleeve 304 is not coextensive with an uppermost portion of the slot 270 of the IDT 252 in the direction of the engagement legs 268 of the IDT 252. In other words, the closed ends of the slots 303 in the sleeve 258 are not aligned with the closed end of the slot 270 in the conductor plate 260 and, instead, are spaced downwardly therefrom.

As generally described above, the sleeve 258 is thin and formed from stainless steel, phosphor bronze or other spring-type alloy. The sleeve 258 may be fabricated from a length of tubing (either seamless or welded seam) that is formed and cut. Alternately, the sleeve 258 may be cut and formed from flat stock, then welded together. The weld can be straight or include a puzzle latch (as partially shown in FIG. 8). The sleeve 258 is substantially thinner than the conductor plate 260. More specifically, the sleeve 258 is at least half as thick as a conductor plate 260. The sleeve 258, however, is not flexible, but rather provides inwardly-directed reaction forces to the outwardly-directed forces from the elastic engagement legs 268 of the conductor plate 260 and their cutters 286 when they engage the wire 254.

The housing 256 is configured for use with the IDT 252. The housing 256 may be formed of plastic and may have a cuboidal shape. The housing 256 may be secured to a second electrical/electronic device, such as a PCB, and, as such, may include features for mounting the housing 256 to the second electrical/electronic device. The housing 256 has an interior pocket 306 with a shape that corresponds to the shape of the IDT 252 and the sleeve 258. The pocket 306 is accessible through an exterior opening in the housing 256. The pocket 306 is formed by a plurality of interior surfaces, including an abutment surface 308 that extends between and through opposing walls 310 of the housing 256. The abutment surface 308 forms the closed ends of slots 312 that are formed in the walls 310 of the housing 256, respectively, and extend into the pocket 306. The slots 312 cooperate with the pocket 306 to form a route through the housing 256.

The IDT 252 may be connected to the wire 254 in the manner described below.

The IDT 252 may be partially inserted into the sleeve 258 through the opening 301 to form a preliminary combination, wherein the free ends of the conductor plate(s) 260 are exposed and the base(s) 262 of the conductor plate(s) 260 and the portions of the engagement legs 268 proximate thereto are exposed. The wire 254 is positioned through the route in the housing 256 to rest against the abutment surface 308 and thereby extend across and through the pocket 306. With the wire 254 so positioned, the preliminary combination of the IDT 252 and the sleeve 258 may be positioned in the pocket 306 such that the wire 254 extends through the center passage 304 of the sleeve 258. Alternately, the sleeve 258 alone may be positioned in the pocket 306 and then the IDT 252 is inserted into the opening 301 of the sleeve 258.

The IDT 252 is pushed downward into the sleeve 258 until the continuous edge defining the opening 301 of the sleeve 258 is about flush with the planar edge of the base 262. As the IDT 252 is pushed downward, the slot 270 moves over the wire 254, thereby bringing the cutters 286 into engagement with the insulation layer. The cutters 286 pierce and/or cut the insulation layer and segments of the copper conductor of the wire 254. The continued movement of the IDT 252 displaces and/or removes portions of the insulation layer and sheared copper segments of the wire 254, which brings the copper conductor of the wire 254 into contact with the interior edges 272 of the IDT 252. Pieces of the insulation layer and sheared copper segments that are removed from the wire 254 may be accommodated at the bottom of the pocket 306. In this regard, the clearance fit between the sleeve 258 and the pocket 306 are small enough to prevent the copper debris from escaping. The copper conductor of the wire 254 is held in the holding portion 270a of the passage 270 and engages the interior edges 272 of the IDT 252, thereby making an electrical connection between the wire 254 and the IDT 252.

As the IDT 252 is pushed over the wire 254 in the manner described above, the wire 254 applies outwardly-directed forces against the convex portions of the interior edges 272, which tends to move the engagement legs 268 outward, against the inward bias of the side walls 305 of the sleeve 258. The sleeve 426 exerts inwardly-directed forces against the engagement legs 268 of the IDT 252, thereby clamping the conductor of the wire 254 between the convex portions of the interior edges 272 of the engagement legs 268. Since the center passage 304 of the sleeve 304 is not coextensive with the uppermost portion of the slot 270 of the IDT 252, the sleeve 304 prevents movement of the wire 254 into the uppermost portion of the slot 270 located toward its closed end.

The use of the sleeve 258 in the pocket 306 avoids issues with plastic creep that may occur if the IDT 252 is placed in direct contact with the plastic defining the pocket 36. In this latter arrangement, plastic creep can cause a diminution in normal forces applied against the engagement legs 268 over time.

In the embodiments disclosed in FIGS. 6-8, the IDCs have the same construction and assembly as the first IDC 250, except for the differences described below.

In the embodiment shown in FIG. 6, the conductor plate has a pair of press-fit fasteners 264 extending from the first edge of the base 262. The press-fit fasteners 264 may each have an eye-of-the-needle (EON) construction. In this type of construction, an opening or piercing 106 is formed in each press-fit fastener 264 so as to define a pair of beams that are resiliently movable toward and away from each other to provide a normal force against a hole in a substrate, such as a hole in a printed circuit board (PCB) 214. Another type of construction that may be used for the press-fit fasteners 264 utilizes beams that are connected together by a web that permits the beams to roll inward to conform to the PCB hole. A particularly suitable web-type of construction that may be used for the press-fit fasteners 264 is shown in U.S. Pat. No. 11,095,057 to Parrish, which is herein incorporated by reference. In this construction, each fastening section includes a pair of beams with a web joined in-between. The web has a center portion disposed between a pair of sloping ramp portions. A pair of holes may extend through the center portion.

The press-fit fasteners 264 may be secured in the holes of the PCB 214, respectively, thereby securing the IDC to the PCB 214. The sleeve 258 is disposed over the conductor plate such that the sleeve 258 is disposed below the press-fit fasteners 264 and, more specifically, between the press-fit fasteners 264 and exposed bottom portions of the engagement legs 268.

In the embodiment shown in FIG. 7, the conductor plate has a single blade projection 265 extending from the first edge of the base 262. The blade projection 265 may be inserted into a socket-type connector of an electrical device to make an electrical connection therewith. The sleeve 258 is disposed over the conductor plate such that the sleeve 258 is disposed below the blade projection 265 and, more specifically, between the blade projection 265 and the exposed bottom portions of the engagement legs 268.

In the embodiment shown in FIG. 8, the conductor plate has a weld projection 266 extending from the first edge of the base 262. The weld projection 266 includes a ridge 320 disposed in a groove of a connector 322, which is secured to a wire 324. The ridge 320 and/or surrounding portions of the weld projection 266 is/are secured to the connector 322 by welding or soldering. The sleeve 258 is disposed over the conductor plate such that the sleeve 258 is disposed below the weld projection 266 and, more specifically, between the weld projection 266 and the exposed bottom portions of the engagement legs 268.

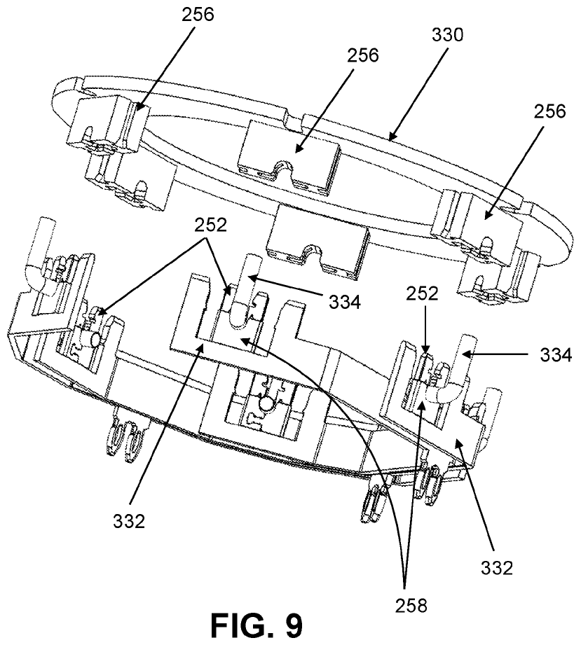

It should be appreciated that in other embodiments, both the housing(s) 256 and the IDT(s) 252 may be integral parts of larger structures. An example of such an embodiment is shown in FIG. 9 in which a plurality of housings 256 are integrally joined to a plastic mounting ring 330 of an electric motor. In addition, a plurality of IDTs 252 are integrally joined to busbars 332, with each busbar 332 having a pair of IDTs 252. The IDTs 252 may each have a single conductor plate 260 that is integrally joined to a busbar 332. Sleeves 258 are mounted to the conductor plates 260, respectively, such that the continuous edges (defining their openings 301) abut edges of the busbars 332. Wires 334 are mounted in the housings 256, respectively, and are engaged by and electrically connected to the conductor plates 260, respectively. The wires 334 may be connected to a stator of the electric motor.

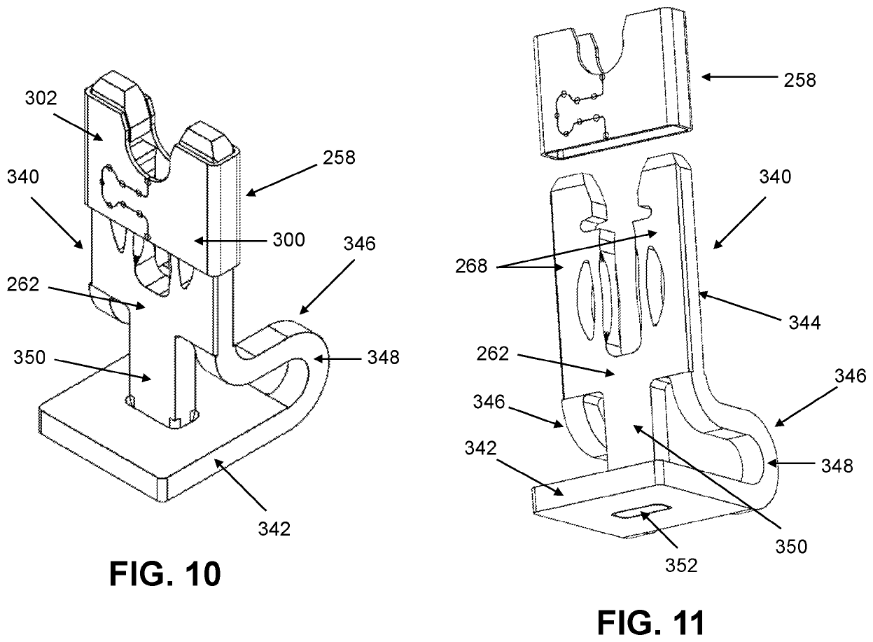

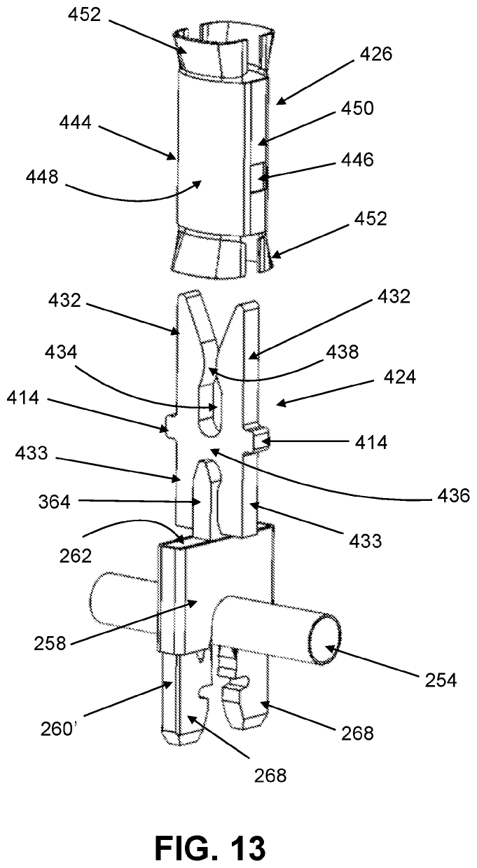

Referring now to FIGS. 10 and 11, there is shown a second IDT 340 for a second IDC constructed in accordance with a second embodiment of the present disclosure. The second IDC includes the second IDT 340, a sleeve 258 and a wire 254 (not shown). The second IDT 340 is configured for surface mounting to a metal pad of a PCB, such as the metal conductor pad 154 of the PCB 156 shown in FIG. 13. The second IDT 340 may be mounted in a housing 256 to form the second IDC.

The second IDT 340 includes a mount 342 joined to a conductor plate 344, which has the same construction as the conductor plate 260, except as described below. The mount 342 is plate-shaped and has a flat bottom surface adapted for mounting to a metal pad, such as on a printed circuit board. Bent first end portions of spring legs 346 are integrally joined to the first edge of the base 262 of the conductor plate 344. Each spring leg 346 extends rearwardly from the conductor plate 344 and is integrally joined by a C-shaped bend 348 to a rear edge of the mount 342. A first end of a center post 350 is integrally joined to the first edge of the base 262, between the legs 346. The center post 350 extends downwardly from the first edge of the base 262 and into an opening 352 in the mount 342. The center post 350 may be welded into the opening 352. The disposition of the center post 350 in the opening 352 allows the center post 350 to provide a strong reaction force in a Z direction (along the length of the center post 350) without slipping in an X or Y direction.

In FIG. 10, the sleeve 258 and the IDT 340 are shown in a preliminary combination in which the second IDT 340 is partially inserted into the sleeve 258 such that the free ends of the conductor plate 344 are exposed and the base 262 of the conductor plate 344 and portions of the engagement legs 268 proximate thereto are exposed.

The IDT 340 may be mounted to the housing 256 in the following manner. With the wire 254 positioned in the route through the housing 256, the preliminary combination of the second IDT 340 and the sleeve 258 may be inserted into the pocket 306 of the housing 256, or the sleeve 258 may be inserted first into the pocket 306 and then the second IDT 340 is inserted into the sleeve 258. The second IDT 340 is then pushed through the sleeve 258 to remove the insulation layer from the wire of the conductor 254 and thereby electrically connect the wire 254 and the second IDT 340.

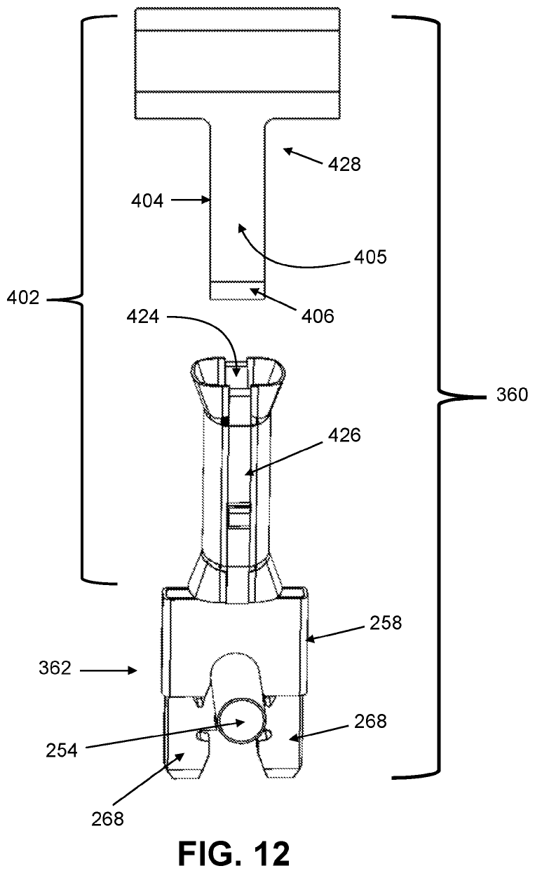

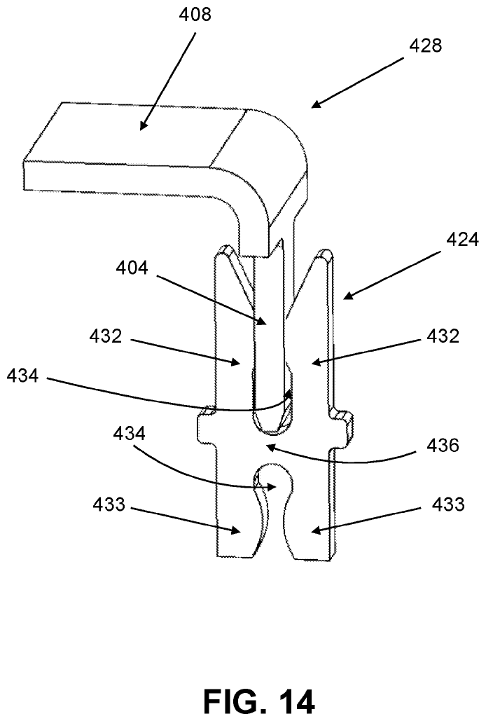

It should also be appreciated that expanded connector assemblies can be provided that combine features of a tuning fork-type connector and an IDC. One such expanded connector assembly 360 and its components are shown in FIGS. 12-14 and includes an IDC 362 connected to a tuning fork-type connector 402.

The IDC 362 has the same construction as the first IDC 250, except the conductor plate 260′ has a blade 364 extending from the top edge of the base 262. The blade 364 is narrower and shorter than the blade projection 265. Although not shown in FIGS. 12-13, it should be appreciated that the IDC 362 may include a housing 256 within which the conductor plate 260′ is mounted.

The connector 402 includes a first conductor 424, a sleeve 426 and a second conductor 428. The first conductor 424 is a connector that is plate-shaped, with opposing planar surfaces, and has the construction described below. The first conductor 424 is configured to be pivotable to better accommodate misalignment.

The first conductor 424 has a first connection portion joined to a second connection portion. The first connection portion is bifurcated and includes arms 432 that are separated by a space or receptacle 434 and are joined to a body 436. Similarly, the second connection portion is bifurcated and includes arms 433 that are separated by a space or receptacle 435 and are joined to the body 436. Protrusions 414 extend outwardly from opposing sides of the body 436. Each arm 432, 433 has an irregular-shaped interior edge 438 that includes a center portion joined by a bulbous center portion to an outer portion.

The second conductor 428 has an end portion comprising an elongated tongue 404 having opposing major surfaces 405 and a beveled free end 406. The end portion is joined at a bend to a main portion 408 so as to be disposed at about a right angle thereto.

The sleeve 426 includes a main body 444 that may generally have the shape of an elliptic cylinder. The main body 444 has opposing arcuate main walls 448 joined together by opposing straight side walls 450. Funnel-shaped collars 452 are joined to opposing ends of the main body 444, respectively. The sleeve 426 defines an interior space that is configured to tightly receive end portions of the first conductor 424 in the direction between the side walls 450.

The sleeve 426 is thin and formed from stainless steel, phosphor bronze or other spring-type alloy. The sleeve 426 may be fabricated from a length of tubing (either seamless or welded seam) that is formed and cut. Alternately, the sleeve 426 may be cut and formed from flat stock, then welded together. The weld can be straight or include a puzzle latch. The sleeve 426 is substantially thinner than the first and second conductors 424, 428. More specifically, the sleeve 426 is at least half as thick as the thinnest portion of the first and second conductors 424, 428.

The sleeve 426 also has rectangular openings 446 formed in the side walls 450, respectively, toward a second end of the main body 444. As will be described more fully below, the openings 446 accommodate the protrusions 414, respectively.

The first and second conductors 424, 428 may be connected together by first mounting the sleeve 426 to the first conductor 424. To do so, the second end of the sleeve 426 is aligned over the first connection portion of the first conductor 424 and then is pressed downward. As the sleeve 426 is pressed downward, the sleeve 426 moves over the first conductor 424 and is temporarily deformed by the protrusions 414 in the direction between the side walls 450 so as to permit the protrusions 414 to enter the openings 446 and extend at least partially therethrough. In addition, exterior edges of the arms 432, 433 adjoin the straight side walls 450 of the sleeve 426 and are aligned with slots in the first and second collars 52.

The blade 364 of the IDC 362 is inserted through the collar 452 at the second end of the sleeve 426 and pressed into the receptacle 435 of the first conductor 424. The movement of the blade 364 between the center portions 442 of the arms 433 applies forces against the arms 433 to move them outward, against the bias of the sleeve 426. As a result, the sleeve 426 elastically deforms to accommodate the expanded arms 433.

The tongue 404 of the second conductor 428 is pressed into the receptacle 434 of the first conductor 424 such that the bevels of its free end 406 slide over the center portions of the interior edges 438 of the arms 432, thereby applying forces against the arms 432 to move them outward, against the bias of the sleeve 426. As a result, the sleeve 426 elastically deforms to accommodate the expanded arms 432. The sleeve 426 exerts inwardly-directed spring forces against the arms 432 of the first conductor 424, thereby clamping the tongue 404 of the second conductor 428 between the center portions of the arms 432. In this manner, the first and second conductors 424, 428 are electrically and mechanically connected together.

The construction of the connector 402 permits the first conductor 424 to pivot about the blade 364 and/or the tongue 404 to accommodate angular and/or translational misalignment of the second conductor 428 and the IDC 362.

It is to be understood that the description of the foregoing exemplary embodiment(s) is (are) intended to be only illustrative, rather than exhaustive. Those of ordinary skill will be able to make certain additions, deletions, and/or modifications to the embodiment(s) of the disclosed subject matter without departing from the spirit of the disclosure or its scope.

1. An insulation displacement connector for making an electrical connection to a wire having an inner metal conductor covered with an outer insulation layer, the insulation displacement connector comprising:
an insulation displacement terminal having a base joined to a pair of spaced-apart legs that define a receptacle configured to receive the wire, the legs having free end portions and interior edges that help define the receptacle, and wherein at least one of the interior edges has a cutter for disrupting the insulation layer of the wire to permit the conductor to directly contact the at least one interior edge having the cutter; and
a sleeve extending around a portion of the insulation displacement terminal and applying inward forces against the legs to bias the legs toward each other, and wherein the sleeve does not extend around the free end portions of the legs.

2. The insulation displacement connector of claim 1, wherein the sleeve is constructed of a first metal and the insulation displacement terminal is constructed of a second metal, and wherein the first and second metals are different.

3. The insulation displacement connector of claim 2, wherein the first metal comprises stainless steel or phosphor bronze and the second metal comprises copper or a copper alloy.

4. The insulation displacement connector of claim 2, wherein the sleeve is thinner than the thickness of each of the legs of the insulation displacement terminal in a direction normal to the direction in the which the legs extend and normal to the direction between the legs.

5. The insulation displacement connector of claim 1, wherein the base forms a closed end of the receptacle; and
wherein the sleeve has a closed peripheral portion that extends around the base and upper portions of the legs.

6. The insulation displacement connector of claim 5, wherein the peripheral portion of the sleeve comprises a waist portion from which leg portions extend, the leg portions being spaced apart to form a passage that extends through the sleeve, and wherein the sleeve has opposing major walls joined between opposing side walls, the major walls and the side walls defining both the waist portion and the leg portions of the sleeve.

7. The insulation displacement connector of claim 6, wherein each of the major walls and the side walls are planar, and wherein the waist portion is substantially rectangular.

8. The insulation displacement connector of claim 6, wherein both of the interior edges of the legs have cutters, and wherein each leg has a hole extending therethrough that forms a spring portion that is resiliently deflectable in a direction normal to the longitudinal direction of the legs.

9. The insulation displacement connector of claim 6, wherein the passage of the sleeve is partially defined by closed ends of sleeve slots in the major walls, respectively, and wherein the closed ends of the sleeve slots are not aligned with the closed end of the receptacle; and
wherein the insulation displacement terminal and the sleeve are configured to be engaged with the wire such that the wire extends through both the receptacle of the insulation displacement terminal and the passage of the sleeve, with the wire abutting the closed ends of the sleeve slots and being spaced from the closed end of the receptacle of the insulation displacement terminal.

10. The insulation displacement connector of claim 1, further comprising a housing having a pair of opposing side walls with slots formed therein and an interior pocket accessible through an exterior opening in the housing, the pocket and the slots defining a route through the housing within which the wire may be placed; and
wherein both the insulation displacement terminal and the sleeve are at least partially disposed in the pocket.

11. The insulation displacement connector of claim 1, wherein the interior edges of the legs each have a holding portion that extends inwardly farther than the rest of the interior edge such that the holding portions define the narrowest portion of the slot.

12. The insulation displacement connector of claim 1, wherein a plurality of press-fit fasteners is joined to an edge of the base, the press-fit fasteners extending in a direction opposite to the direction in the which the legs extend.

13. The insulation displacement connector of claim 1, wherein the insulation displacement terminal further comprises a mount connected to the base, the mount having a planar bottom surface adapted for surface mounting to a metal pad.

14. The insulation displacement connector of claim 13, wherein the base is integrally joined to an elongated center post, which extends in a direction opposite to the direction in the which the legs extend.

15. The insulation displacement connector of claim 14, wherein the mount has an opening within which a free end of the center post is disposed.

16. The insulation displacement connector of claim 1, wherein the insulation displacement terminal further comprises a blade extending from an edge of the base in a direction opposite to the direction in the which the legs extend.

17. A connector assembly comprising the insulation displacement connector of claim 16, and further comprising:
a first conductor having a first connection portion with a pair of spaced-apart first arms defining a first receptacle in-between, and a second connection portion with a pair of spaced-apart second arms defining a second receptacle in-between; and
wherein the blade of the insulation displacement terminal is disposed in the second receptacle.

18. The connector assembly of claim 17, further comprising a second sleeve having a peripheral portion that extends around the first arms of the first conductor along at least a portion of the length of the first arms.

19. The connector assembly of claim 18, wherein the peripheral portion comprises a continuous wall having arcuate portions joined between planar side portions; and
wherein the planar side portions of the continuous wall press against exterior edges of the first and second arms.

20. The connector assembly of claim 19, further comprising:
a second conductor comprising a tongue having opposing planar surfaces, the tongue being disposed in the first receptacle such that the planar surfaces adjoin interior edges of the first arms of the first conductor.
